(19) United States
(12) Patent Application Publication
(10) Pub. No.: US 2026/0252699 A1
(43) Pub. Date: Aug. 27, 2026

(54) MANAGING STARTUP OF A DATA PROCESSING SYSTEM USING TRUST STORES

(71) Applicant: Dell Products L.P., Round Rock, TX (US)

(72) Inventors: NICHOLAS D. GROBELNY, Evergreen, CO (US); AMY CHRISTINE NELSON, Round Rock, TX (US); DAVID ALBERT CONSOLVER, Hurst, TX (US); RAMAN SHARMA, Leander, TX (US); RICHARD M. TONRY, Georgetown, TX (US)

(21) Appl. No.: 19/062,673

(22) Filed: Feb. 25, 2025

(51) Int. Cl. G06F 21/57; G06F 21/44; G06F 21/60

(52) U.S. Cl. CPC G06F 21/575; G06F 21/44; G06F 21/604

(57) ABSTRACT

Methods and systems for managing operation of a data processing system are disclosed. To manage operation of the data processing system, during a startup of the data processing system, an entity may obtain, using a security protocol and data model (SDPM) security standard, at least a first device certificate of a certificate chain for a device. Using the at least the first device certificate and a store of trusted device certificates, the entity may perform a first analysis process to determine a level of trust in the device. If the level of trust is indeterminate, the entity may use the certificate chain and a store of trusted root certificates to perform a second analysis process to determine the level of trust in the device. Operation of the data processing system may be managed based on the level of trust in the device.

### FIELD

Embodiments disclosed herein relate generally to managing operation of a data processing system. More particularly, embodiments disclosed herein relate to systems and methods to manage startup of a data processing system using trust stores.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIGS. 3A-3B show flow diagrams illustrating a method for managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may include hardware and/or software components that, in some combination, may be used to provide computer-implemented services. To provide the computer-implemented services, the data processing system may undergo a startup during which functionality of a portion of its hardware and/or software components may be enabled.

During the startup, a startup manager (e.g., a basic input/output system (BIOS)) of the data processing system (and/or any other entity) may perform tasks such as: (i) obtaining cryptographically verifiable certificate chains from the hardware components (e.g., devices), and (ii) performing certificate analysis processes using the certificate chains to establish trust by the data processing system in the devices. Doing so may reduce a risk of compromise of the data processing system, errors occurring during startup, etc.

However, the startup manager may have a limited capacity to perform the startup tasks (e.g., due to its host hardware and/or program code). For example, operation of the startup manager may be limited by a single processor that executes instructions one after the other in a specific order (e.g., as in sequential processing). Since each of the startup tasks may also have some degree of time dependence, these limitations may cause bottlenecks (e.g., delays in completion of the startup). Such delays may consume an undesirable amount of computational and/or time resources, which may negatively affect the quality and/or availability of the computer-implemented services.

To improve startup speed, thereby reducing a resource consumption during startup, trust stores may be used by the startup manager during the startup to establish trust in a device. To do so, the startup manager may obtain at least a first device certificate for the device (e.g., a portion of the certificate chain), and may perform a first analysis process using the at least the first device certificate and the store of trusted device certificates to determine a level of trust in the device. The level of trust may be: (i) trusted (e.g., if the at least the first device certificate matches a known good device certificate in the store of trusted device certificates), (ii) untrusted (e.g., if the at least the first device certificate matches a known bad device certificate in the store of trusted device certificates), and/or (iii) indeterminate (e.g., if the at least the first device certificate does not match a known good and/or known bad device certificate). A digest of the at least the first device certificate may also be obtained and used to perform the first analysis process in a similar manner.

If the level of trust is indeterminate, the startup manager may perform a second analysis process to determine the level of trust in the device using a store of trusted root certificates and the certificate chain for the device. Performing the second analysis process may include: (i) performing a signature verification process to establish trust in each portion of the certificate chain, (ii) identifying, using the store of trusted root certificates, whether a root certificate authority for the root certificate is trusted by the startup manager to obtain the level of trust, and/or (iii) updating the store of trusted device certificates (e.g., if the level of trust is trusted) for use during future startups of the data processing system.

Thus, embodiments disclosed herein may address, among other technical problems, the technical challenge of performing a startup of a data processing system in a manner that conserves resources while maintaining an acceptable level of security of the data processing system. By using a store of trusted device certificates and a store of trusted root certificates, a full certificate analysis process may not have to be performed for each device operably connected to the data processing system during each startup. Consequently, startup time may be reduced, and computer-implemented services may be provided in a timely manner.

In an embodiment, a method for managing operation of a data processing system is disclosed. The method may include: during a startup of a data processing system: obtaining, by an entity of the data processing system and using a security protocol and data model (SPDM) security standard, at least a first device certificate of a certificate chain for a device of the data processing system, the certificate chain including the at least the first device certificate and a root certificate; performing, by the entity and using the at least the first device certificate and a store of trusted device certificates, a first analysis process to determine a level of trust in the device; in a first instance of the performing in which the level of trust in the device is indeterminate: performing, by the entity and using the certificate chain and a store of trusted root certificates, a second analysis process to determine the level of trust in the device; and managing operation of the data processing system based on the level of trust in the device to reduce a likelihood of the data processing system being compromised.

The store of trusted device certificates may include device certificates and/or digests of device certificates.

Performing the first analysis process may include: obtaining a digest of the at least the first device certificate; and identifying, based on the digest of the at least the first device certificate and the digests of device certificates in the store of trusted device certificates, the level of trust in the device.

Performing the second analysis process may include: performing a signature verification process to establish trust in each portion of the certificate chain; identifying, using the store of trusted root certificates, whether a root certificate authority for the root certificate is trusted by the entity to obtain the level of trust in the device; and in an instance of the identifying in which the level of trust is trusted: updating the store of trusted device certificates for use during future startups of the data processing system.

The method may also include: in a second instance of the performing the first analysis process in which the level of trust in the device is trusted: performing, by the entity, a measurement process using the SDPM security standard for the device to obtain at least one measurement; and managing operation of the device based on the at least one measurement.

The at least one measurement may include security data usable to validate authenticity and/or integrity of software hosted by the device.

No other portions of the certificate chain other than the first device certificate may be used during the first analysis process.

The method may also include: in a third instance of the performing the first analysis process in which the level of trust in the device is untrusted: preventing the device from performing at least a portion of its functionality and/or logging information regarding trustworthiness of the device.

The SPDM security standard may be a data model for devices of data processing systems, the SPDM security standard specifying, at least, methods of security communication between the devices, minimum standards of data to be made available to other devices, and security information to be made available to the other devices.

The entity of the data processing system may be a basic input-output system (BIOS).

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

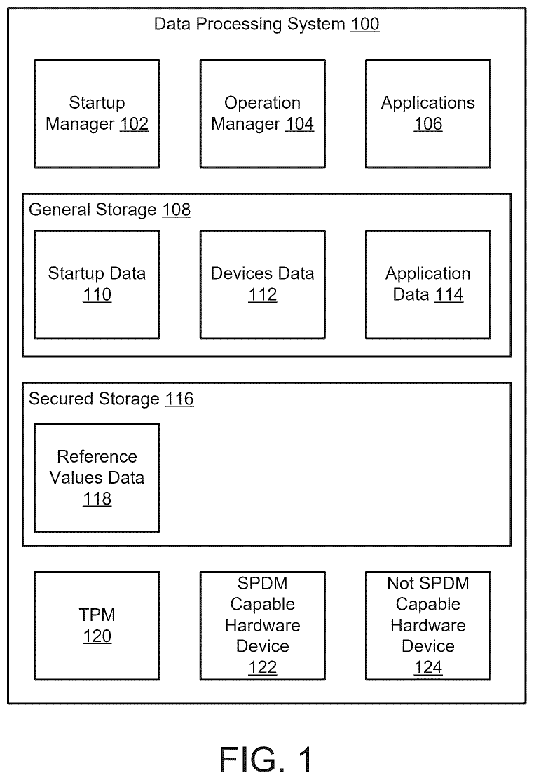

Turning to FIG. 1, a block diagram illustrating a system in accordance with an embodiment is shown. The system shown in FIG. 1 may provide computer-implemented services. The computer-implemented services may include, for example, database services, data processing services, communication services, and/or any other services that may be provided using one or more computing devices. Other types of computer-implemented services may be provided by the system without departing from embodiments disclosed herein.

To provide the computer-implemented services, the system (e.g., a data processing system) may undergo a startup during which functionality of a portion of its hardware and/or software components may be enabled. For example, the computer-implemented services may require access to processors, memory modules, storage devices, communication devices, and/or other devices operably connected to the data processing system. The hardware components (e.g., devices) may support execution of any number and/or type of software components (e.g., applications), and, in some combination, the hardware and software components may provide for various types of computer-implemented services.

To perform the startup, a startup manager of the data processing system (e.g., a basic input/output system (BIOS)) may access, verify, and use data stored by the data processing system and/or retrieved from the hardware components (e.g., startup data). The startup data may include instructions corresponding to software usable to facilitate various tasks of the startup (e.g., tasks for performing device verification and initialization, and/or other tasks related to enabling and/or securing hardware functionality), data structures usable to verify the integrity and/or authenticity of the software hosted by the hardware components (e.g., firmware), and/or data structures usable to establish trust in hardware components (e.g., device certificates, certificate chains).

For example, during a secure boot (e.g., a type of startup) of the data processing system, the tasks may include security checks where integrity of portions of the startup data are validated (e.g., secure boot verification). The secure boot verification may be performed (e.g., using reference values data stored by the data processing system, using a security manager of the data processing system such as a trusted platform module) in order to establish trust in each portion of the startup data before use (e.g., execution), so that exposure to malicious or erroneous software is unlikely. Doing so may reduce a risk of compromise of the data processing system, errors occurring during startup, etc.

The tasks associated with the startup may be performed by the startup manager in sequence throughout the startup process. By performing the tasks associated with the startup in sequence, the risk of compromise of the data processing system may be further reduced.

To perform the tasks associated with the startup, the startup manager may communicate with the hardware components (e.g., devices) using a predefined industry standard, such as the security protocol and data model (e.g., SPDM) security standard. Communicating with the devices using the SPDM security standard may allow the startup manager to retrieve data structures from the devices usable to verify the integrity and/or authenticity of the software hosted by the devices and/or analyze certificate chains for the devices in a manner that establishes an acceptable level of trust that the devices will not compromise the data processing system once booted.

For example, establishing an acceptable level of trust in the devices may include performing a certificate analysis process. During the certificate analysis process, a signature verification process may be performed to establish trust in each portion of a certificate chain (e.g., the certificate chain may be cryptographically validated). Performing the certificate analysis process may also include verifying that a root certificate authority for the certificate chain is trusted by the data processing system.

Performing the certificate analysis process for each device may be performed in sequence during the startup. However, the startup manager may have a limited capacity to perform the startup tasks (e.g., due to its host hardware and/or program code). For example, operation of the startup manager may be limited by a single processor that executes instructions one after the other in a specific order (e.g., as in sequential processing). Since each of the startup tasks may also have some degree of time dependence, these limitations may cause bottlenecks (e.g., delays in completion of the startup process). Such delays may consume an undesirable amount of computational and/or time resources, which may negatively affect the quality and/or availability of the computer-implemented services.

In general, embodiments disclosed herein may provide methods, systems, and/or devices for managing startup of a data processing system in a manner that improves startup speed. To do so, an entity of the data processing system (e.g., a startup manager such as the BIOS and/or any other entity) may obtain at least a first device certificate of a certificate chain for a device of the data processing system. The certificate chain for the device may include at least the first device certificate and a root certificate (e.g., signed by a root certificate authority). The entity may perform a first analysis process using the at least the first device certificate and a store of trusted device certificates to determine a level of trust in the device. The entity may determine that the level of trust is: (i) trusted, (ii) untrusted, and/or (iii) indeterminate.

The entity may determine that the level of trust is indeterminate, for example, if the at least the first device certificate does not match (and/or otherwise correspond to) a device certificate in the store of trusted device certificates. If the level of trust is indeterminate, the entity may perform a second analysis process using the certificate chain and a store of trusted root certificates to determine the level of trust in the device. Performing the second analysis process may include establishing trust in each portion of the certificate chain, and/or identifying whether the root certificate authority for the root certificate is trusted by the entity using the store of trusted root certificates. If the root certificate authority is trusted by the entity, the level of trust in the device may be trusted, and the store of trusted device certificates may be updated (e.g., to include a copy of the first device certificate, a digest of the first device certificate, and/or other information) to facilitate future startups of the data processing system.

By doing so, embodiments disclosed herein may conserve computational and time resources during startup of a data processing system. By determining a level of trust in a device using a store of trusted device certificates and a store of trusted root certificates, a certificate analysis process may not be required to be performed for each device of the data processing system during every startup. By reducing the number of devices for which the certificate analysis is to be performed during the startup, startup time may be reduced while maintaining an acceptable level of security during a boot process. Consequently, the computer-implemented services may be provided in a timely manner while reducing computational resources consumed.

To provide the above noted functionality, the system of FIG. 1 may include data processing system 100, startup manager 102, operation manager 104, applications 106, general storage 108, secured storage 116, trusted platform module (TPM) 120, security protocol and data model (SPDM) capable hardware device 122, and not SPDM capable hardware device 124. Each of these components is discussed below.

Data processing system 100 may include any number of hardware components (e.g., processors, memory modules, storage devices, communications chips, other devices). The hardware components may support execution of any number and/or type of software components (e.g., startup manager 102, operation manager 104, applications 106, etc.).

Data processing system 100 may provide any number and type of computer-implemented services. To provide the computer-implemented services, data processing system 100 may include startup manager 102. Startup manager 102 may include a startup management entity (e.g., a basic input/output system (BIOS)) hosted by a hardware processor of data processing system 100 and may facilitate management of startup of data processing system 100 from power on to booting to operation manager 104. The startup of data processing system 100 may include performing a secure boot procedure. During the secure boot procedure, startup manager 102 may perform tasks related to device verification and initialization, and/or other tasks related to enabling and/or securing hardware functionality.

To perform its functionality, startup manager 102 (e.g., a startup management entity) may: (i) perform device enumeration tasks to obtain a list of devices (e.g., hardware components) operably connected to data processing system 100 which are compliant with a security protocol and data model (SPDM) security standard (e.g., including obtaining identifiers for the devices such as globally unique identifiers (GUIDs)), (ii) collect, using the SPDM security standard, startup data from the devices in the list of devices, the startup data including portions of certificate chains (e.g., device certificates), full certificate chains, and/or other data, (iii) obtain, using any type and/or quantity of predetermined functions (e.g., hash functions, other algorithms) digests for the device certificates, root certificates, and/or any other portion of the certificate chains, (iv) perform analysis processes to determine, using at least a store of trusted device certificates (e.g., stored as part of reference values data 118), a level of trust in each device (e.g., trusted, untrusted, and/or indeterminate), (v) perform analysis processes using the certificate chains (e.g., for devices for which a level of trust was unable to be determined using device certificates) to determine the level of trust using a store of trusted root certificates, (vi) obtain device measurements (e.g., as part of startup data 110) following the SPDM security standard for the devices, (vii) update the store of trusted device certificates using information obtained while performing any processes during the startup, (viii) provide the device measurements to a trusted platform module (TPM) of data processing system 100 to perform verification processes to verify the integrity and/or authenticity of the devices (e.g., using reference values data 118), (ix) boot to operation manager 104, restrict capabilities of operation manager 104, and/or prevent booting to operation manager 104 based on an outcome of the verification processes, and/or (x) perform other tasks.

The devices operably connected to data processing system 100 may be compliant with the SPDM security protocol (e.g., SPDM capable hardware device 122) or may not be compliant with the SPDM security protocol (e.g., not SPDM capable hardware device 124). SPDM capable hardware device 122 may include a device with SPDM capabilities. For example, SPDM capable hardware device 122 may be designed to comply with the SPDM security standard managed by the Distributed Management Task Force (DMTF). Complying with the SPDM security standard may allow the device to have its identity authenticated and its integrity verified in a manner that allows startup manager 102 to have an acceptable level of trust that the device is not compromised and/or malicious. Not SPDM capable hardware device 124 may be unable to have its identity authenticated and/or its integrity verified in the manner that allows startup manager 102 to have the acceptable level of trust. Thus, not SPDM capable hardware device 124 may be prevented from booting and/or may have a portion of its functionality restricted during operation of data processing system 100 (or at least until subsequent verification procedures are performed).

While described with respect to determining whether a device is compliant with the SPDM security protocol managed by the DMTF, it will be appreciated that device compliance with any other security standard may be determined in a similar manner without departing from embodiments disclosed herein.

Devices data 112 may include an existing list (and/or may be implemented using, for example, tables, unstructured data, trees, databases, etc.) for which startup manager 102 and/or any other entity has previously obtained information regarding SPDM capabilities. For example, devices data 112 may include an identifier for a device, and an indication corresponding to the identifier regarding whether the device is compliant with the SPDM security standard.

Devices data 112 may be stored in general storage 108 and may be used by startup manager 102 to determine whether any of the devices are new devices. For example, startup manager 102 may obtain an identifier for a graphics processing unit (GPU) during device enumeration. Startup manager 102 may perform a lookup process in a table of devices and corresponding SPDM capabilities included in devices data 112 using the identifier as a key for the lookup process. If startup manager 102 determines that the GPU is a new device (e.g., no entries in the table of devices correspond to the identifier), startup manager 102 may proceed to obtain the SPDM capabilities of the GPU.

The SPDM capabilities for a new device may be obtained by checking the firmware and/or system documentation of the new device to determine whether the new device supports the SPDM security standard. A dedicated tool and/or command may be used to query the new device for its specific SPDM capabilities, including supported cryptographic algorithms and/or certificate formats (e.g., via an SPDM message exchange with the new device to retrieve its identity certificate and/or associated details about its security features). Any information obtained from the new device while obtaining the SPDM capabilities of the new device may be added to devices data 112 and used during subsequent startups of data processing system 100.

For the SPDM security standard compliant devices (e.g., SPDM capable hardware device 122), startup manager 102 may obtain startup data 110 from the devices following the SPDM security standard. Startup data 110 may include data structures obtained from the devices that are usable to identify an acceptable manner of managing operation of the devices by startup manager 102 (e.g., using identification data such as device certificates, root certificates, certificate chains, digests of the device certificates, root certificates, and/or certificate chains). For example, the data structures obtained from the devices as part of startup data 110 may be usable to determine levels of trust in the devices. Operation of the data processing system and/or devices may be managed based on the levels of trust (e.g., based on a policy and/or other rule set for managing devices).

Startup data 110 may also include measurements obtained from SPDM security standard compliant devices. The measurements may be usable to verify the integrity and/or authenticity of the software hosted by the devices. The measurements may be obtained for all and/or a portion of the SPDM security standard compliant devices. For example, the measurements may be obtained from devices determined by startup manager 102 to have a trusted level of trust (and/or may be obtained for any devices for which a policy indicates a measurement process is to be performed). The measurements may include cryptographic hashes, digital fingerprints, and/or other data structures that indicate the current state of a device's firmware, configuration, and/or other characteristics of the components. Startup manager 102 may perform the measurement process and may provide the measurements to trusted platform module (TPM) 120 to perform verification processes to verify the integrity and/or authenticity of the devices (e.g., using reference values data 118). Based on an outcome of the verification processes (e.g., a report generated by TPM 120), startup manager 102 may boot to operation manager 104, restrict capabilities of operation manager 104, and/or prevent booting to operation manager 104.

TPM 120 may be a hardware component that is distinguishable from the hardware processor that hosts startup manager 102 and may provide security management services for data processing system 100 (e.g., may comply with ISO/IEC 11889:2009, any of the TPM main specification such as Version 2.0, and/or may conform operation to other industry standards). To provide the security management services, TPM 120 may (e.g., in collaboration with startup manager 102): (i) facilitate verification of startup data 110 using reference values data 118 to establish trust in each portion of startup data 110 before use (e.g., execution), so that exposure to malicious or erroneous software is unlikely (e.g., is not executed), (ii) store and restrict use of secrets (e.g., public/private keys, etc.) based on security posture of data processing system 100, and (iii) facilitate the identification of (e.g., in collaboration with software components of the data processing system such as startup manager 102) the security posture of data processing system 100 based on measurements of various components (e.g., firmware hosted by various devices (e.g., 122, 124), software loaded into data processing system 100, hardware/software component presence/absence, etc.) of data processing system 100. Reference values data 118 may include secure boot data usable to verify the integrity and trust in startup data 110 (e.g., various portions of startup data 110) prior to use of (the various portions of) startup data 110. For example, reference values data 118 may include hashes and/or other types of information usable to cryptographically verify trust and integrity of startup data 110. TPM 120 may include data (e.g., a hash, a signature, etc.) usable to verify integrity of reference values data 118.

Reference values data 118 may also include trust stores, which may include data usable to determine levels of trust for at least a portion of the devices operably connected to the data processing system. The trust stores may: (i) be populated by startup manager 102 upon establishing trust in a device (e.g., by performing an analysis process to establish trust in a root certificate authority of a root certificate), and/or (ii) may be established by a management entity of data processing system 100 (e.g., a manufacturer of the data processing system) and/or another trusted entity. For example, reference values data 118 may include: (i) a store of trusted device certificates (e.g., including device/leaf certificates, digests of device certificates, public keys usable to perform signature verification processes, other identifiers for devices and corresponding levels of trust), and/or (ii) a store of trusted root certificates (e.g., including root certificates, identifiers for root certificate authorities, levels of trust corresponding to the root certificates and/or root certificate authorities, public keys usable to perform signature verification processes).

Reference values data 118 may be stored in secured storage 116. Secured storage 116 may include a hardware storage device for storing data. For example, secured storage 116 may be implemented with a solid state storage device operably connected via a serial peripheral interface (SPI) bus to a processor of data processing system 100. Access to secured storage 116 may be restricted to certain entities and/or for certain uses. For example, secured storage 116 may only be accessible by startup manager 102 and/or TPM 120 for performing tasks during and/or related to startup. The contents of secured storage 116 may be generally inaccessible without providing various credentials such as passwords.

Once the device measurements have been provided to TPM 120 (e.g., and presuming data processing system 100 has been determined to be in a predetermined state using, at least in part, TPM 120), startup manager 102 may hand off management of the operation of data processing system 100 to operation manager 104. Operation manager 104 may include, for example, an operating system, drivers, and/or other entities through which applications 106 may provide all, or a portion of, their functionality. Operation manager 104 may be booted to using startup data 110. Thus, if startup data 110 includes malicious code, undesired code, unauthorized code, etc., then operation manager 104 may operate in a manner that diverges from a desired manner. To reduce this possibility, as discussed above, startup manager 102 may perform various actions to improve a likelihood that data processing system 100 operates in a predetermined (e.g., desired) manner.

Applications 106 may include any type and quantity of applications (e.g., software components) that may provide any type and quantity of computer-implemented services. To do so, applications 106 may generate, store, modify, read, and/or otherwise use application data 114 stored in general storage 108.

General storage 108 may be implemented using physical devices that provide data storage services (e.g., storing data and providing copies of previously stored data). The devices that provide data storage services may include hardware devices and/or logical devices. For example, general storage 108 may include any quantity and/or combination of memory devices (e.g., volatile storage), long term storage devices (e.g., persistent storage), other types of hardware devices that may provide short term and/or long term data storage services, and/or logical storage devices (e.g., virtual persistent storage/virtual volatile storage). General storage 108 may be accessible. For example, operation manager 104 may manage and provide access to data stored in general storage 108.

When providing their functionalities, applications 106 may utilize the functionality of operation manager 104 (e.g., to access computing resources such as processor cycles, transitory storage space, etc.). Thus, if operation manager 104 does not operate in the predetermined manner, then applications 106 may also operate in a manner that diverges from a desired and/or expected manner. The divergence of applications 106 and/or operation manager 104 may cause data processing system 100 to not provide (or provide in a compromised manner) all, or a portion, of the computer-implemented services that are to be provided by data processing system 100.

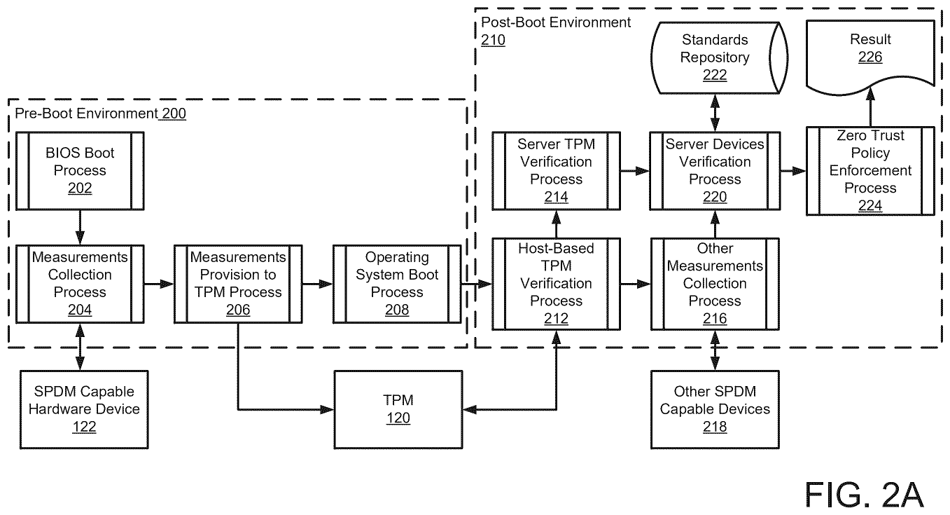

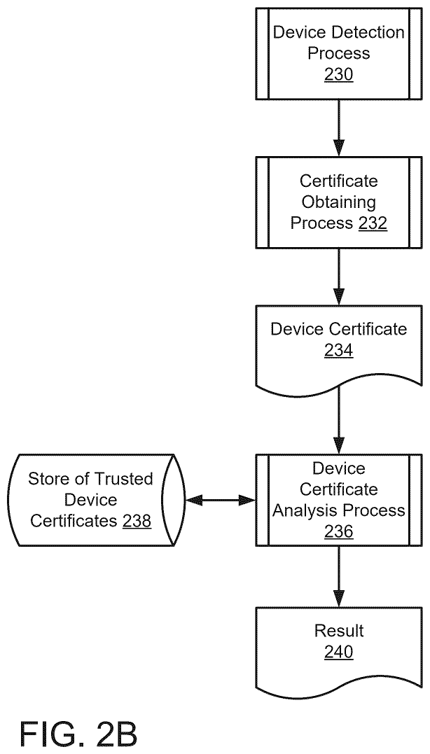

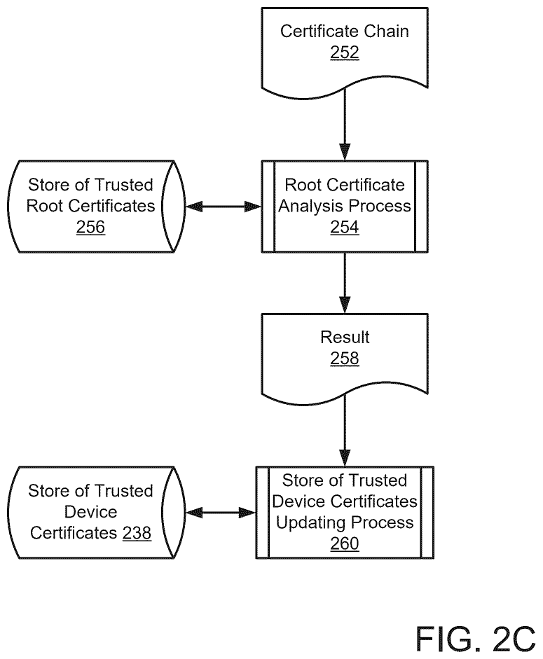

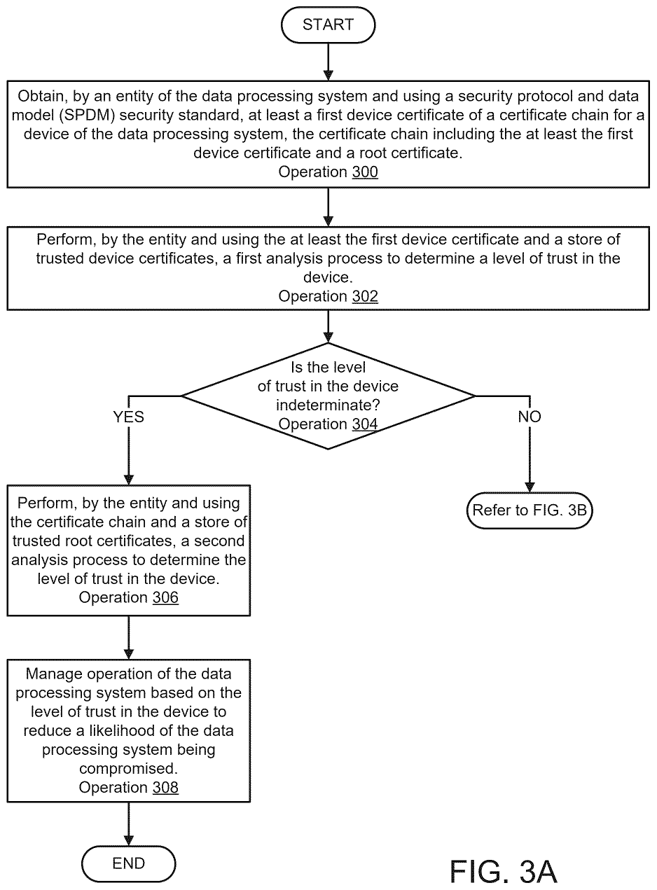

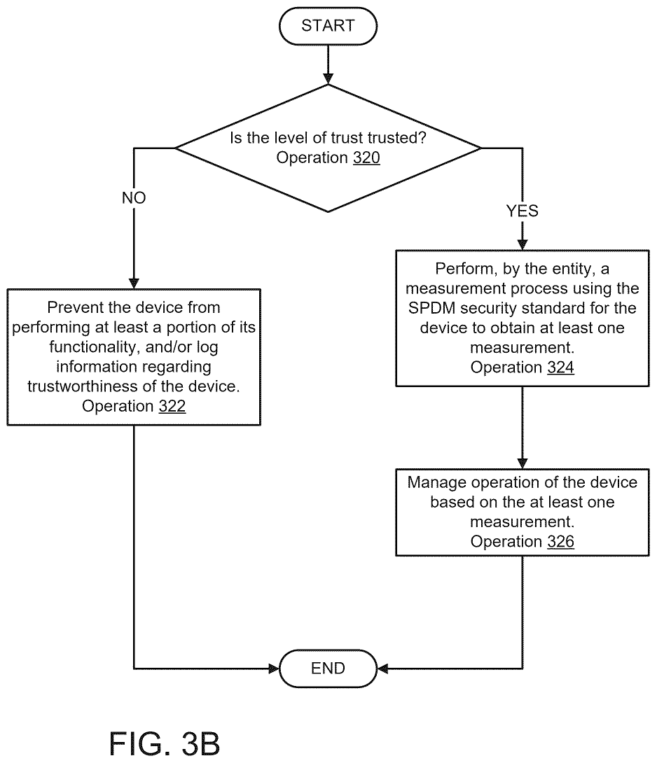

When providing their functionality, any components of data processing system 100 may perform all, or a portion, of the actions and methods illustrated in FIGS. 2A-3B.

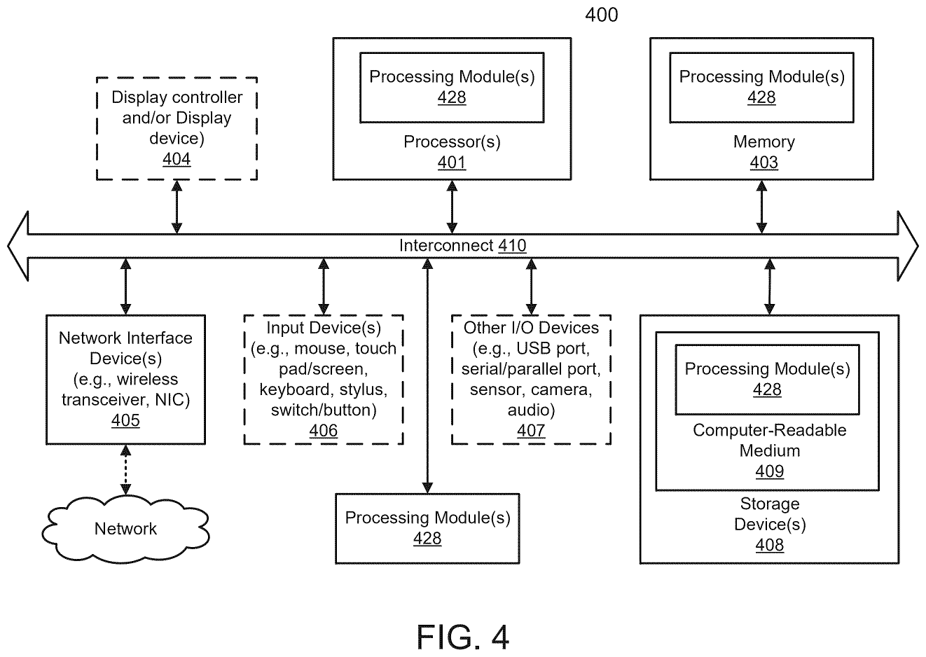

Data processing system 100 (and/or components thereof) may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 226, 234, etc.) is used to represent data structures, a second set of shapes (e.g., 202, 204, etc.) is used to represent processes performed using and/or that generate data, a third set of shapes (e.g., 222, 238, etc.) is used to represent large scale data structures such as databases, and a fourth set of shapes (e.g., 122, 120, etc.) is used to represent hardware components (e.g., also referred to as devices).

Turning to FIG. 2A, a first data flow diagram in accordance with an embodiment is shown. The first data flow diagram may illustrate data used in and data processing performed in managing operation of a data processing system (e.g., similar to data processing system 100 shown in FIG. 1) in a manner that improves a likelihood that the data processing system operates as desired.

To manage operation of the data processing system, generally, a startup process may be performed. The startup process may cause the environment of the data processing system to evolve over time from a pre-boot environment (e.g., 200) to a post-boot environment (e.g., 210) where the data processing system may be in condition to provide desired computer-implemented services. Generally, pre-boot environment 200 refers to the state of the data processing system prior to handing off management to a general management entity, and post-boot environment 210 refers to the state of the data processing system after handing off management to the general management entity (e.g., an operating system). During the startup, various processes may be performed, as will be discussed below, to place the data processing system into a desired security posture where it is less susceptible to malicious attacks.

To begin the startup, basic input/output system (BIOS) boot process 202 (or other types of boot processes, such as to unified extensible firmware based entities, it should be appreciated that BIOS boot process 202 refers to any such processes) may be performed. BIOS boot process 202 may be initiated by powering on the data processing system or resetting the system. During BIOS boot process 202, the BIOS program code may be loaded by a processor (e.g., via a serial peripheral interface (SPI) bus and from a protected storage such as secured storage 116). The BIOS may perform tasks related to startup management for the data processing system during pre-boot environment 200 (e.g., similar to startup manager 102 shown in FIG. 1). For example, the BIOS may perform a secure boot procedure to check program code (e.g., firmware) of various hardware and/or software components (e.g., drivers) in a predefined sequence. Pre-boot environment 200 may include operations performed (e.g., by the BIOS) to hand off management of the data processing system to an operation manager (e.g., an operating system) of the data processing system.

Once the BIOS has been booted, measurements collection process 204 may be performed. During measurements collection process 204, security data may be collected from the hardware and/or software components of the data processing system. The security data may include identification data such as device certificates and/or certificate chains, and/or measurements (e.g., refer to the description of startup data 110 shown in FIG. 1). The security data may be usable to identify an acceptable manner of managing operation of the hardware components by the BIOS and/or verify the authenticity and/or integrity of software hosted by the hardware components using trusted data structures. The identification data obtained as part of the security data may include cryptographically verifiable certificates and/or digests of the certificates. The measurements obtained as part of the security data may include data structures including cryptographic hashes or digital fingerprints that represent the current state of a device's firmware, configuration, drivers, management entity code, and/or other components that may be modified in undesired manners.

For example, the BIOS may perform measurements collection process 204 based on a security protocol and data model (SPDM) security standard. The SPDM security standard may be a data model for hardware components/devices of data processing systems, which may specify, at least: (i) methods of security communication between the hardware components, (ii) minimum standards of data to be made available to other hardware components, (iii) security information to be made available to the other hardware components, and/or (iv) other information. When performing measurements collection process 204, a list of hardware components of the data processing system that are compliant with the SPDM security standard may be obtained. The list of hardware components may be obtained using: (i) an existing list of hardware components that are compliant with the SPDM security standard, and (ii) any new hardware components of the data processing system that are not identified in the existing list.

To collect the measurements from the hardware components, the hardware components may be required to be compliant with the SPDM security standard (e.g., SPDM capable hardware device 122). Compliance with the SPDM security standard may allow the measurements to be collected in a format, using communication protocols, and/or including information specified by the SPDM security standard (e.g., managed by the Distributed Management Task Force (DMTF)). The measurements may be usable to establish an acceptable level of trust that the hardware components will not act maliciously towards the data processing system. For additional details regarding measurements collection process 204, refer to FIGS. 2B-2C.

The measurements collected from the hardware components during measurements collection process 204 may be used to perform measurements provision to trusted platform module (TPM) process 206. During measurements provision to TPM process 206, the BIOS may provide the measurements to the TPM of the data processing system (e.g., TPM 120). TPM 120 may include (and/or may be included as part of) a secure hardware component (e.g., a chip) with physical security mechanisms that reduce a likelihood of malicious and/or erroneous software compromising the data processing system (e.g., by verifying the authenticity and/or integrity of software hosted by various hardware components). The measurements may be provided to TPM 120 following a set of specifications and/or standards such as the Trusted Computing Group PC Client Platform Firmware Profile (TCP PFP). TPM 120 (e.g., reports generated by TPM 120) may then be used to compute a security posture of the data processing system (e.g., in collaboration with startup manager 102). Based on the security posture determined, at least in part, using TPM 120, booting may be allowed to proceed, some functions of the data processing system may be limited, and/or other remedial actions may be performed should the security posture not meet certain requirements (e.g., activity facilitated by the TPM may be policy driven, with the policies being keyed to the security posture of the data processing system as calculated using the TPM). Refer to the description of FIG. 1 for additional details regarding TPM 120.

Once the measurements have been provided to TPM 120 (e.g., and presuming that the measurements indicate an acceptable security posture), operating system boot process 208 may be performed. During operating system boot process 208, program code for an operating system and/or other type of operational management entity (e.g., operation manager 104 shown in FIG. 1) may be loaded onto the processor and booted so that management of the operation of the data processing system may be handed off from the BIOS to the operating system. After the handoff, the BIOS may shut down, be placed in standby, etc. Management may be handed off to the operating system to place the data processing system into a predetermined manner of operation (e.g., a manner of operation that supports execution of applications). The operating system may, for example, provide abstracted access to resources utilized by the applications, manage data storage and data retrieval, and/or perform other actions that allow for the applications that provide (all or a portion of) the computer-implemented services to execute on the data processing system.

Booting the operating system may indicate a transition from pre-boot environment 200 to post-boot environment 210. Post-boot environment 210 may include operations performed (e.g., by a management entity of the data processing system such as the operating system) to manage operation of the data processing system based on a security posture of the data processing system (e.g., established using TPM 120).

Once the operating system is booted, host-based TPM verification process 212 may be performed (e.g., a host-based verification process may be performed using the TPM of the data processing system). During host-based TPM verification process 212, TPM 120 may perform tasks related to security management of the data processing system. To do so, measurements obtained from the BIOS may be used to perform security verification processes of the hardware and/or software components using TPM 120. For example, reports generated by TPM 120 may be used to verify the authenticity and/or integrity of untrusted data structures (e.g., the measurements) using trusted data structures, such as trusted hashes, and security programs such as a signature verification algorithm. The trusted data structures may be established during manufacturing of the data processing system and may be stored in TPM 120 and/or may be obtained by TPM 120 from trusted data sources (e.g., a unified extensible firmware (UEFI) signature database).

Host-based TPM verification process 212 may establish a security posture of the data processing system. The security posture may be based on a result of the security verification processes performed using TPM 120. For example, if, using reports generated by TPM 120, the authenticity and/or integrity of all and/or a portion of the hardware components is unable to be verified (e.g., the security posture includes indications of compromise), actions may be performed to reduce the likelihood of compromise of the data processing system. The actions may include limiting use of secrets managed by TPM 120 by the data processing system (e.g., the operating system) based on the security posture of the data processing system and/or performing other actions. The actions performed using TPM 120 may result in limited and/or reduced functionality of the operating system.

If at least one hardware component is unable to be verified using TPM 120 (e.g., using reports generated by TPM 120 trust is unable to be established in software hosted by the at least one hardware component), the measurements obtained from the at least one hardware component may be provided to a remote entity (e.g., a server and/or any other management system for the data processing system). The measurements collected from the at least one hardware component may be used to perform server TPM verification process 214. During server TPM verification process 214, the remote entity may perform tasks related to verifying the integrity and/or authenticity of the at least one hardware component. To do so, the remote entity may use a data structure including expected integrity measurements of the at least one hardware component's software (e.g., a Trusted Computing Group (TCG) system refence integrity manifest). The remote entity may provide a response to the operating system indicating whether the at least one hardware component is verified.

To reduce the amount of time to complete booting of the data processing system, some devices (e.g., not necessary to boot the data processing system) may not be initialized until after operation of the data processing system is handed off to the operating system. To verify those devices, other measurements collection process 216 may be performed. During other measurements collection process 216, measurements usable to verify the authenticity and/or integrity of software hosted by the devices (e.g., other SPDM capable devices 218) may be obtained (e.g., by the operating system). The measurements may be obtained based on an SPDM security standard and other SPDM capable devices 218 may be compliant with the SPDM security standard.

To verify the measurements obtained from other SPDM capable devices 218, server devices verification process 220 may be performed. During server devices verification process 220, the measurements may be provided to a remote system (e.g., a server and/or other backend system) and used to perform the device verification processes remotely. To perform the device verification processes, the remote system may use trusted data structures stored in standards repository 222 to verify the untrusted data structures (e.g., the measurements). Standards repository 222 may include a database of trusted integrity measurements (e.g., a TCG component reference integrity manifest) which may be used to establish trust in the measurements from each device of other SPDM capable devices 218.

An outcome of any of the device verification processes performed by components of the data processing system and/or remote entities may be used to perform zero trust policy enforcement process 224. The outcome may include an indication of whether any of the hardware components are unable to be verified (e.g., whether trust in any of the hardware components is unable to be established). During zero trust policy enforcement process 224, remedial measures may be performed (e.g., by the operating system) if the outcome indicates a hardware component is unable to be verified. The remedial measures may be based on a predetermined zero trust policy that may reduce a likelihood of compromise and/or other undesired impacts on the data processing system. For example, the zero trust policy may include: (i) preventing the hardware component that is unable to be verified from booting, (ii) shutting down the data processing system, (iii) providing a notification to a user of the data processing system indicating the hardware component is unable to be verified, (iv) obtaining user input regarding any actions that are to be performed as a result of the hardware component being unable to be verified, and/or (v) other remedial measures.

As a result of performing zero trust policy enforcement process 224, result 226 may be obtained. Result 226 may include instructions for the operating system and/or any other management entity of the data processing system to perform various remedial measures based on the zero trust policy. Based on result 226, the operating system may manage operation of the data processing system.

Thus, by implementing the data flow shown in FIG. 2A, a system in accordance with embodiments disclosed herein may be used to manage operation of a data processing system in a manner that reduces a likelihood of the data processing system becoming compromised and/or operating in an undesired manner. Consequently, computer-implemented services provided using the data processing system may be provided as desired.

Turning to FIG. 2B, a second data flow diagram in accordance with an embodiment is shown. The second data flow diagram may illustrate data used in and data processing performed in determining a level of trust in a device using at least a first device certificate (e.g., device certificate 234) and a store of trusted device certificates (e.g., store of trusted device certificates 238). FIG. 2B may include an expansion of measurements collection process 204 shown in FIG. 2A.

To determine the level of trust in the device, device detection process 230 may be performed by an entity of the data processing system (e.g., a startup manager such as the BIOS similar to startup manager 102 described in FIG. 1). Device detection process 230 may be performed following basic input/output system (BIOS) boot process 202 described in FIG. 2A.

During device detection process 230, the entity may perform enumeration tasks to identify devices (e.g., also referred to as hardware components) operably connected to the data processing system and obtain identifiers for the devices, such as globally unique identifiers (GUIDs) and/or other unique codes and/or numbers usable to identify the devices. The identifiers for any detected devices and/or other information obtained from the detected devices may be used to perform certificate obtaining process 232.

During certificate obtaining process 232, the entity may obtain all and/or a portion of a cryptographically verifiable certificate chain for a device detected during device detection process 230. The certificate chain may include: (i) a first device certificate for the device (e.g., device certificate 234), (ii) any number of intermediate certificates (e.g., certificates issued by intermediate certificate authorities that link device certificate 234 to a root certificate), and (iii) the root certificate (e.g., signed by a root certificate authority). The certificate chain may be usable to identify an acceptable manner of managing operation of the device by the entity. For example, the certificate chain may be usable to establish trust in the device by the data processing system (e.g., by verifying the identity of the device). Based on the degree to which the data processing system is able to establish trust, the data processing system may identify and perform actions to dictate a manner and/or extent to which the device is allowed to interact with the data processing system.

To obtain all and/or a portion of the certificate chain, the entity may initiate an SPDM message exchange with the device. As a result, at least device certificate 234 may be obtained. Device certificate 234 may include the first device certificate (e.g., a leaf certificate) of the certificate chain for the device. Device certificate 234 may be a data structure including: (i) information regarding the device (e.g., an identifier for the device, a public key corresponding to a public-private key pair managed by the device), (ii) information regarding a certificate authority that issued device certificate 234 (e.g., an identifier for the certificate authority, a signature from the certificate authority, a public key corresponding to a public-private key pair managed by the certificate authority), (iii) a validity date for device certificate 234, and/or (iv) other information.

Upon obtaining device certificate 234, device certificate analysis process 236 may be performed. During device certificate analysis process 236, a first analysis process may be performed by the entity to determine a level of trust in the device using at least device certificate 234 and store of trusted device certificates 238. Store of trusted device certificates 238 may be a part of reference values data 118 described in FIG. 1, and may include device certificates and/or digests of device certificates (e.g., hashes of device certificates and/or other representations of device certificates obtained by applying any number and type of algorithms to the device certificates) for devices and classifications for the device certificates and/or digests corresponding to levels of trust.

For example, the device certificates and/or digests included in store of trusted device certificates 238 may be classified as: (i) known good (e.g., certificates and/or digests for devices having a trusted level of trust), (ii) known bad (e.g., certificates and/or digests for devices having an untrusted level of trust), and/or (iii) other information and/or classifications for device certificates and/or digests. For example, known good device certificates and/or digests may be included in store of trusted device certificates 238 for devices produced by a manufacturer of the data processing system (e.g., and therefore the devices may be trusted to not act maliciously towards the data processing system). Known bad device certificates and/or digests, for example, may include certificates and/or digests for potentially malicious devices, devices with identified security issues, and/or otherwise unsupported devices (e.g., and therefore the devices may not be trusted to not act maliciously towards the data processing system).

To determine the level of trust in the device during device certificate analysis process 236, at least device certificate 234 and/or a digest of device certificate 234 may be compared to device certificates and/or digests included in store of trusted device certificates 238. For example, the entity may perform a search in store of trusted device certificates 238 using at least a portion of device certificate 234 as a key for the search to identify whether device certificate 234 corresponds to a known good and/or known bad device certificate included in store of trusted device certificates 238. Based on the identification, the level of trust in the device may be determined.

In another example, the digest of device certificate 234 may be used to determine the level of trust in the device. To do so, the digest of device certificate 234 may be obtained by the entity. Obtaining the digest of device certificate 234 may include applying, by the entity, a predetermined function (e.g., a hash function and/or other algorithm, the predetermined function may also include a plurality of functions) to device certificate 234 to obtain the digest of device certificate 234. Obtaining the digest of device certificate 234 may also include: (i) providing, by the entity, a request for the digest of device certificate 234 to the device, and (ii) receiving the digest of device certificate 234 from the device in response to the request. Based on the digest of device certificate 234 and digests included in store of trusted device certificates 238, the level of trust for the device may be identified (e.g., the digest of device certificate 234 may be used as a key for the search performed in store of trusted device certificates 238).

For example, a startup manager of the data processing system (e.g., the entity) may detect a graphics processing unit (GPU) operably connected to the data processing system during device detection process 230. In a first example, the startup manager may obtain a digest of a first device certificate for the GPU by obtaining, using the SPDM security standard, the first device certificate for the GPU and applying a predetermined hash function (e.g., SHA-256, SHA-512, SHAKE) to the first device certificate. In a second example, the startup manager may obtain the digest of the first device certificate by requesting the digest of the first device certificate from the GPU, and receiving the digest of the first device certificate in response (e.g., the digest of the first device certificate may be stored in the GPU and/or computed by the GPU).

During the first analysis process performed as part of device certificate analysis process 236, no other portions of the certificate chain other than device certificate 234 (e.g., the first device certificate for the device) may be used to determine the level of trust in the device. For example, the level of trust may be determined during device certificate analysis process 236 by comparing device certificate 234 to data structures included in store of trusted device certificates 238, rather than by performing a certificate analysis process to verify the full certificate chain. In doing so, an amount of time to determine the level of trust in the device may be reduced.

While described with respect to using only the first device certificate for the device to determine the level of trust in the device, it will be appreciated that other portions of the certificate chain may be used to determine the level of trust. For example, the first device certificate and a first intermediate certificate of the certificate chain may be used to determine the level of trust in the device using processes similar to those described with respect to the first analysis process.

An outcome of performing device certificate analysis process 236 may include result 240. Result 240 may indicate a level of trust in the device, which may include: (i) a trusted level of trust, (ii) an untrusted level of trust, and/or (iii) an indeterminate level of trust. A trusted level of trust may be obtained if device certificate 234 matches a known good device certificate and/or digest included in store of trusted device certificates 238. For example, a digest of device certificate 234 may match a known good digest when a difference between the digest of device certificate 234 hash value and a known good hash value (e.g., a known good digest) is zero (e.g., the hash values match).

Similarly, an untrusted level of trust may be obtained if device certificate 234 matches a known bad device certificate and/or digest included in store of trusted device certificates 238 (e.g., a difference between the digest of device certificate 234 hash value and a known bad hash value is zero).

An indeterminate level of trust may be obtained if device certificate 234 and/or a digest of device certificate 234 does not match a device certificate and/or digest included in store of trusted device certificates 238. For example, an indeterminate level of trust may be obtained for the device if the digest of device certificate 234 does not match a digest included in store of trusted device certificates 238 (e.g., a difference between the digest of device certificate 234 hash value and hash values included in store of trusted device certificates 238 is nonzero).

If result 240 indicates the level of trust is trusted, the entity may perform a measurement process using the SPDM security standard (e.g., via an SPDM message exchange) for the device to obtain at least one measurement. The at least one measurement may include security data (e.g., hashes of software code hosted by the device) usable to validate authenticity and/or integrity of software hosted by the device. Refer to the description of FIG. 2A for additional details regarding obtaining device measurements using the SPDM security standard.

Performing the measurement process may include verifying the measurement to evaluate a security posture of the data processing system. To do so, a TPM of the data processing system (e.g., similar to TPM 120 shown in FIG. 1 and FIG. 2A) may be used to check the integrity and/or authenticity of the software hosted by the device (e.g., using the at least one measurement and data structures trusted by the TPM).

Based on the at least one measurement, operation of the device may be managed (e.g., based on a policy and/or other rule set for managing operation of devices). For example, if the at least one measurement is able to be verified (e.g., the at least one measurement is a trusted measurement), at least a portion of the functionality of the device may be enabled (e.g., the device may be allowed to perform at least a portion of its functions and/or interact with the data processing system as requested by the device). If the at least one measurement is not able to be verified as trusted, functionality of the device may be restricted and/or other actions may be performed to reduce a likelihood of the data processing system being compromised.

If result 240 indicates the level of trust is untrusted: (i) the device may be prevented from performing at least a portion of its functionality (e.g., the device may be restricted from performing functions and/or interactions between the device and the data processing system may be limited), (ii) information regarding trustworthiness of the device may be logged (e.g., an identifier for the device and/or other information obtained from the device and/or as a result of performing the first analysis process may be added to a log maintained by the BIOS, operating system, and/or any other entity), (iii) the device may be quarantined (e.g., until the device can be verified via other methods such as a certificate analysis process), (iv) activity of the device may be screened for indications of malicious behavior, and/or (v) other actions may be performed.

If result 240 indicates the level of trust is indeterminate, the entity may perform a second analysis process using the certificate chain and a store of trusted root certificates to determine the level of trust in the device. Refer to the description of FIG. 2C for additional details regarding performing the second analysis process.

Thus, by implementing the data flow shown in FIG. 2B, a system in accordance with embodiments disclosed herein may be used to determine a level of trust in a device using a store of trusted device certificates. By comparing at least a first device certificate for the device to device certificates and/or digests of device certificates in the store of trusted device certificates, the level of trust in the device may be obtained in a manner that improves startup speed while maintaining a desired level of security, which may reduce a resource consumption during startup.

Turning to FIG. 2C, a third data flow diagram in accordance with an embodiment is shown. The third data flow diagram may illustrate data used in and data processing performed in determining a level of trust in a device using a certificate chain for the device (e.g., certificate chain 252) and a store of trusted root certificates (e.g., store of trusted root certificates 256). FIG. 2B may include an expansion of measurements collection process 204 shown in FIG. 2A.

To determine the level of trust in the device, certificate chain 252 may be obtained to perform root certificate analysis process 254. Certificate chain 252 may include a certificate chain for the device (refer to the description of FIG. 2B for additional details regarding certificate chains). Certificate chain 252 may be obtained by an entity of the data processing system (e.g., such as the BIOS) via an SPDM message exchange: (i) upon detection of the device (e.g., at a time when a first device certificate is obtained, refer to FIG. 2B), and/or (ii) upon obtaining an untrusted level of trust for the device using at least the first device certificate.

In a first example, a network interface card (NIC) (e.g., an SPDM compliant device) may be detected during a startup of the data processing system. The BIOS (e.g., the entity) may request and obtain a first device certificate for the NIC via an SPDM message exchange. The first device certificate may be used to perform the first analysis process. If it is determined that the level of trust is indeterminate using the first device certificate, the BIOS may request and obtain the certificate chain from the NIC via an SPDM message exchange to perform root certificate analysis process 254.

In a second example, the BIOS may request and obtain the certificate chain from the NIC card via an SPDM message exchange upon detection of the NIC card. The first device certificate of the certificate chain may be used to perform the first analysis process. If it is determined that the level of trust is indeterminate using the first device certificate, the certificate chain may be used to perform root certificate analysis process 254.

Using certificate chain 252, root certificate analysis process 254 may be performed. During root certificate analysis process 254, a second analysis process may be performed using certificate chain 252 and store of trusted root certificates 256 to determine the level of trust in the device. During the second analysis process, a signature verification process may be performed to establish trust in each portion of certificate chain 252 (e.g., each certificate of certificate chain 252). The signature verification process may include using, by the entity, a public key of a public-private key pair to verify the authenticity of the private key used by the certificate issuer (e.g., the certificate authority) to sign each certificate of the certificate chain. A chain of trust may be established by verifying each certificate authority's certificate up to the root certificate authority of certificate chain 252.

If trust in each portion of certificate chain 252 is established, it may be identified whether the root certificate authority for the root certificate of certificate chain 252 is trusted by the entity using store of trusted root certificates 256. Store of trusted root certificates 256 may be a part of reference values data 118 described in FIG. 1, and may include: (i) root certificates and/or digests of root certificates (e.g., hashes of root certificates and/or other representations of root certificates obtained by applying any number and type of algorithms to the root certificates), (ii) signatures of root certificate authorities, (iii) public keys of public-private key pairs managed by the root certificate authorities usable to perform signature verification processes, (iv) classifications for the root certificates, digests, and/or root certificate authorities corresponding to levels of trust, and/or (v) other information.

For example, the root certificates, digests, and/or root certificate authorities included in store of trusted root certificates 256 may be classified as: (i) known good (e.g., having a trusted level of trust), (ii) known bad (e.g., having an untrusted level of trust), and/or (iii) other classifications for root certificates, digests, and/or root certificate authorities. For example, a known good root certificate authority included in store of trusted root certificates 256 may include a manufacturer of the data processing system. Devices having certificate chains including a root certificate signed by the manufacturer of the data processing system may therefore be trusted to not act maliciously towards the data processing system.

To identify whether the root certificate authority for the root certificate of certificate chain 252 is trusted by the entity, the root certificate, a digest of the root certificate (e.g., obtained as part of certificate chain 252 and/or by applying a predetermined function to the root certificate, refer to FIG. 2B), an identifier for the root certificate authority, and/or other information regarding the root certificate authority may be compared to data structures included in store of trusted root certificates 256. For example, an identifier for the root certificate authority may be used as a key for a search in store of trusted root certificates 256. In doing so, it may be identified whether the root certificate, digest, and/or root certificate authority for certificate chain 252 corresponds to a known good and/or known bad root certificate, digest, and/or root certificate authority.

By performing root certificate analysis process 254, result 258 may be obtained. Result 258 may indicate a level of trust in the device based on the identification, which may include: (i) a trusted level of trust, (ii) an untrusted level of trust, and/or (iii) an indeterminate level of trust. A trusted level of trust may be obtained if the root certificate authority for the root certificate is trusted by the entity (e.g., the root certificate, digest, and/or root certificate authority of certificate chain 252 corresponds to a known good root certificate, digest, and/or root certificate authority included in store of trusted root certificates 256). Similarly, an untrusted level of trust may be obtained if the root certificate authority for the root certificate is not trusted by the entity (e.g., the root certificate, digest, and/or root certificate authority of certificate chain 252 corresponds to a known bad root certificate, digest, and/or root certificate authority included in store of trusted root certificates 256). An indeterminate level of trust may be obtained if the root certificate, digest, and/or root certificate authority of certificate chain 252 does not correspond to a root certificate, digest, and/or root certificate authority included in store of trusted root certificates 256.

Based on the level of trust indicated by result 258, operation of the data processing system may be managed to reduce a likelihood of the data processing system being compromised. For example, at least one action may be performed (e.g., based on a policy for managing the data processing system, based on input obtained from a user of the data processing system) to manage operation of the data processing system. The at least one action may include: (i) preventing the device from performing at least a portion of its functionality (e.g., restricting the device from performing functions and/or limiting interactions with the data processing system), (ii) allowing the device to perform at least a portion of its functionality (e.g., enabling the device to perform at least a portion of its functions and/or interact with the data processing system as requested by the device), (iii) performing, by the entity, a measurement process using the SPDM security standard for the device (e.g., to verify the integrity and/or authenticity of software hosted by the device prior to booting the device), (iv) logging information regarding the device (e.g., in a log maintained by the BIOS, operating system, and/or any other entity), (v) quarantining the device (e.g., until the device can be verified via other methods such as a certificate analysis process), (vi) screening activity of the device for indications of malicious behavior, (vii) notifying a user and/or managing entity of the data processing system regarding the trustworthiness of the device, and/or (viii) other actions.

If result 258 indicates that the level of trust for the device is trusted, the at least one action may also include performing store of trusted device certificates updating process 260. During store of trusted device certificates updating process 260, store of trusted device certificates 238 may be updated to include: (i) the at least the first device certificate of certificate chain 252, (ii) a digest of the at least the first device certificate of certificate chain 252, (iii) an indication that the device has a trusted level of trust, and/or (iv) other information usable to identify the trusted level of trust in the device. The updated store of trusted device certificates 238 may be used during future startups of the data processing system.

Consider a scenario in which a GPU is detected by the BIOS during startup. The GPU may be a new device (e.g., the GPU may not have been previously connected to the data processing system). The BIOS may obtain a first device certificate for the GPU via an SPDM message exchange with the GPU. The first device certificate and/or a digest of the first device certificate may be compared to device certificates and/or digests in store of trusted device certificates 238, and an indeterminate level of trust may be obtained for the GPU (e.g., the first device certificate and/or digest may not match any device certificates and/or digests in store of trusted device certificates 238). The BIOS may then obtain the certificate chain for the GPU via an SPDM message exchange. A signature verification process may be performed for the certificate chain, and a root certificate of the certificate chain may be identified. The root certificate and/or digest of the root certificate may be compared to root certificates and/or digests included in store of trusted root certificates 256, and a trusted level of trust for the GPU may be obtained (e.g., the root certificate and/or digest may match a known good root certificate and/or digest). Store of trusted device certificates 238 may then be updated to include the first device certificate and/or the digest of the first device certificate for the GPU and may indicate that the first device certificate and/or digest for the GPU is known good (e.g., trusted). In doing so, the GPU may be recognized as a having a trusted level of trust during subsequent startups of the data processing system.

Thus, by implementing the data flows shown in FIGS. 2A-2C, a system in accordance with embodiments disclosed herein may be used to improve startup speed of a data processing system while maintaining a desired level of security. By doing so, a resource cost (e.g., computational resources, time resources) of performing the startup may be reduced. Consequently, resources may be allocated to providing computer-implemented services and a likelihood that the computer-implemented services may be provided as desired may be increased.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2C may perform various methods to manage data used to provide computer-implemented services. FIGS. 3A-3B illustrate a method that may be performed by the components of the system of FIGS. 1-2C. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method for managing operation of a data processing system in accordance with an embodiment is shown. The method may be performed, for example, by any of the components of the system of FIG. 1, and/or any other entity without departing from embodiments disclosed herein. The method may be performed during a startup of the data processing system.

At operation 300, at least a first device certificate of a certificate chain for a device of the data processing system may be obtained by an entity of the data processing using a security protocol and data model (SPDM) security standard, the certificate chain including the at least the first device certificate and a root certificate. Obtaining the first device certificate may include: (i) providing, by the entity and via an SPDM message exchange with the device, a request for the at least the first device certificate to the device and receiving the at least the first device certificate in response, (ii) reading the at least the first device certificate from storage, (iii) receiving the at least the first device certificate from another entity, and/or (iv) other methods. Obtaining the at least the first device certificate may also include: (i) obtaining, by the entity, the certificate chain from the device, (ii) obtaining, from the certificate chain, the at least the first device certificate, and/or (iii) other methods. The entity may also obtain a data structure representing the at least the first device certificate from the device, such as a digest of the at least the first device certificate (e.g., a hash of the at least the first device certificate and/or other representation).

At operation 302, a first analysis process may be performed by the entity using the at least the first device certificate and a store of trusted device certificates to determine a level of trust in the device. Performing the first analysis process may include: (i) obtaining a digest of the at least the first device certificate, (ii) identifying, based on the digest of the at least the first device certificate and digests of device certificates in the store of trusted device certificates, the level of trust in the device, (iii) receiving the level of trust from another entity responsible for performing the first analysis process, and/or (iv) other methods.

Obtaining the digest of the at least the first device certificate may include: (i) requesting the digest from the device and receiving the digest in response, (ii) applying a predetermined function to the at least the first device certificate to obtain the digest, (iii) receiving the digest from another entity, (iv) reading the digest from storage, and/or (v) other methods.

Applying the predetermined function to the at least the first device certificate to obtain the digest may include: (i) using the at least the first device certificate as input to an algorithm, such as a hash function and/or any other type and/or quantity of functions, (ii) obtaining, as output from the algorithm, the digest, (iii) providing, by the entity, the at least the first device certificate and/or instructions for applying the predetermined function to the at least the first device certificate to another entity and receiving the digest in response, and/or (iv) other methods.

Identifying the level of trust in the device based on the digest of the at least the first device certificate and the digest of device certificates in the store of trusted device certificates may include: (i) comparing the digest to digests included in the store of trusted device certificates, (ii) obtaining a result of the comparing, the result indicating whether the digest matches (and/or otherwise agrees with) a digest included in the store of trusted device certificates (e.g., reading the result, receiving the result from another entity), (iii) identifying, based on the result, the level of trust in the device, and/or (iv) other methods.

Comparing the digest to digests included in the store of trusted device certificates may include: (i) performing a matching process to determine whether the digest matches any digests included in the store of trusted device certificates, (ii) performing any other comparison process to determine whether the digest agrees with a digest included in the store of trusted device certificates, (iii) providing the digest to another entity (e.g., an entity with access to and/or that is responsible for managing the store of trusted device certificates) responsible for comparing the digest to digests included in the store of trusted device certificates, and/or (iv) other methods.

Identifying the level of trust in the device may include: (i) determining which classification of digest the digest matches (and/or otherwise agrees with), the classification including a known good digest and/or a known bad digest, (ii) assigning the level of trust to the digest based on the classification, and/or (iii) other methods. In a first example, if the digest matches a known good digest, the level of trust may be trusted. In a second example, if the digest matches a known bad digest, the level of trust may be untrusted. If the digest does not match a known good digest and/or a known bad digest, the level of trust may be identified as indeterminate.

Performing the first analysis process may also include identifying, based on the at least the first device certificate and the device certificates in the store of trusted device certificates, the level of trust in the device. To do so, similar methods may be performed as those described with respect to determining the level of trust in the device using the digest of the at least the first device certificate.

At operation 304, it may be determined whether the level of trust in the device is indeterminate. Determining whether the level of trust in the device is indeterminate may include: (i) reading a result of the first analysis process indicating the level of trust (e.g., from storage), (ii) receiving the determination from another entity, and/or (iii) other methods.

If it is determined that the level of trust in the device is indeterminate (e.g., the determination is “Yes” at operation 304), then the method may proceed to operation 306.

At operation 306, a second analysis process may be performed by the entity and using the certificate chain and a store of trusted root certificates to determine the level of trust in the device. Performing the second analysis process may include: (i) performing a signature verification process to establish trust in each portion of the certificate chain, (ii) identifying, using the store of trusted root certificates, whether a root certificate authority for the root certificate is trusted by the entity to obtain the level of trust in the device (iii) in an instance of the identifying in which the level of trust is trusted: updating the store of trusted device certificates for use during future startups of the data processing system, (iv) receiving the level of trust from another entity responsible for performing the second analysis process, and/or (v) other methods.

Performing the signature verification process may include: (i) using, by the entity, a public key of a public-private key pair to verify the authenticity of a private key used by a certificate issuer (e.g., a certificate authority) to sign the first device certificate, (ii) repeating the signature verification process for each portion (e.g., certificate) of the certificate chain to establish a chain of trust, (iii) providing the certificate chain to another entity responsible for performing the signature verification process, and/or (iv) other methods.

Identifying whether the root certificate authority for the root certificate is trusted by the entity to obtain the level of trust in the device may include: (i) identifying the root certificate authority for the certificate chain (e.g., that signed the root certificate of the certificate chain), (ii) obtaining an identifier for the root certificate authority, (iii) comparing the identifier, the root certificate, and/or a digest of the root certificate to identifiers, root certificates, and/or digests of root certificate included in the store of trusted root certificates, (iv) making a determination, based on the comparing, regarding whether the root certificate authority is trusted, (v) obtaining, based on the determination, the level of trust for the device, and/or (v) other methods. For example, if the identifier, the root certificate, and/or the digest of the root certificate matches a known good identifier, root certificate, and/or digest included in the store of trusted root certificates, the root certificate authority may be trusted and the level of trust for the device may be trusted. If the identifier, the root certificate, and/or the digest of the root certificate matches a known bad identifier, root certificate, and/or digest included in the store of trusted root certificates, the root certificate authority may be untrusted and the level of trust for the device may be untrusted. If the identifier, the root certificate, and/or the digest of the root certificate does not match an identifier, root certificate, and/or digest included in the store of trusted root certificates, the level of trust for the device may be indeterminate.

Updating the store of trusted device certificates (e.g., if the level of trust in the device is trusted) may include: (i) adding an entry to the store of trusted device certificates, the entry including the at least the first device certificate, the digest of the at least the first device certificate, an identifier for the device, an indication that the level of trust in the device is trusted, and/or other information, (ii) providing a message to another entity including instructions for updating the store of trusted device certificates to include information indicating the trusted level of trust in the device, and/or (iii) other methods.

At operation 308, operation of the data processing system may be managed based on the level of trust in the device to reduce a likelihood of the data processing system being compromised. Managing operation of the data processing system may include: (i) identifying at least one action to manage the operation of the data processing system based on the level of trust in the device, (ii) performing the at least one action, and/or (iii) other methods.

Identifying the at least one action may include: (i) obtaining a policy (e.g., including a rule set, schema, and/or any other data structure) usable to determine the at least one action based on the level of trust in the device (e.g., reading the policy from storage, receiving the policy from another entity, generating the policy), (ii) performing a search using the policy and at least the level of trust as a key for the search to identify the at least one action, (iii) providing the level of trust to another entity responsible for identifying the at least one action and receiving the at least one action in response, and/or (iv) other methods.

Performing the at least one action may include: (i) preventing the device from performing at least a portion of its functionality (e.g., preventing the device from booting, restricting access by the device to data stored on the data processing system, restricting an ability of the device to communicate with the data processing system), (ii) allowing the device to perform at least a portion of its functionality (e.g., permitting the device to boot, allowing the device to access data stored on the data processing system, allowing the device to communicate with the data processing system), (iii) performing, by the entity, a measurement process using the SPDM security standard for the device (refer to the description of FIG. 3B for additional details), (iv) logging information regarding the device (e.g., generating an entry in a log including the level of trust for the device and/or other information regarding the device, providing the level of trust and/or other information regarding the device to another entity responsible for logging the information), (v) quarantining the device (e.g., isolating the device until a trusted level of trust for the device is established), (vi) screening activity of the device for malicious behavior, and/or (vii) other methods.

The method may end following operation 308.

Returning to operation 304, if it is determined that the level of trust in the device is not indeterminate (e.g., the level of trust is trusted or untrusted, the determination is “No” at operation 304), then the method may include performing operations described in FIG. 3B.

Turning to FIG. 3B, a second flow diagram illustrating a method for managing operation of a data processing system in accordance with an embodiment is shown. The method may be performed, for example, by any of the components of the system of FIG. 1, and/or any other entity without departing from embodiments disclosed herein. Operations shown in FIG. 3B may be performed if the determination is “No” at operation 304 shown in FIG. 3A.

At operation 320, it may be determined whether the level of trust in the device is trusted. Determining whether the level of trust is trusted may include: (i) identifying whether at least a first device certificate for the device indicates that the level of trust is trusted, (ii) receiving a message from another entity indicating that the level of trust is trusted, (iii) reading the level of trust from storage, and/or (iv) other methods.

Identifying whether the at least a first device certificate indicates the level of trust is trusted may include methods similar to those described with respect to operation 302 in FIG. 3A. For example, the level of trust in the device may be trusted if the at least the first device certificate and/or a digest of the at least the first device certificate matches a known good device certificate and/or digest included in the store of trusted device certificates.

If it is determined that the level of trust is not trusted (e.g., the level of trust is untrusted, the determination is “No” at operation 320), then the method may proceed to operation 322.

At operation 322, the device may be prevented from performing at least a portion of its functionality, and/or information regarding trustworthiness of the hardware component may be logged. Preventing the device from performing at least a portion of its functionality and/or logging information regarding trustworthiness of the device may include: (i) preventing the device from booting, (ii) restricting access by the device to data stored on the data processing system, (iii) restricting an ability of the device to communicate with the data processing system, (iv) generating an entry in a log indicating that the level of trust for the device is untrusted, and/or (v) other methods.

Returning to operation 320, if it is determined that the level of trust is trusted (e.g., the determination is “Yes” at operation 320), then the method may proceed to operation 324.

At operation 324, a measurement process may be performed for the device by the entity and using the SPDM security standard to obtain at least one measurement. Performing the measurement process may include: (i) obtaining, by the entity, the at least one measurement from the device, (ii) analyzing the at least one measurement to determine whether the at least one measurement is a trusted measurement, and/or (iii) other methods.

Obtaining the at least one measurement may include: (i) performing an SPDM message exchange (e.g., initiated by the entity) with the device to obtain the at least one measurement, (ii) requesting the at least one measurement from another entity (e.g., an intermediate entity) and receiving the at least one measurement in response, (iii) reading the at least one measurement from storage, and/or (iv) other methods.

Analyzing the at least one measurement to determine whether the at least one measurement is a trusted measurement may include: (i) obtaining trusted data structures (e.g., stored in a TPM of the data processing system, from data sources trusted by the TPM such as a UEFI signature database), (ii) comparing the at least one measurement to the trusted data structures to obtain a result indicating whether the at least one measurement is the trusted measurement, (iii) providing the at least one measurement to another entity (e.g., a remote entity such as a server) and receiving a response indicating whether the at least one measurement is the trusted measurement, and/or (iv) other methods.

For example, the at least one measurement may include a hash value of a portion of software hosted by the device generated using a predetermined hash function. Analyzing the at least one measurement may include comparing the hash value to a known good hash value trusted by the TPM (e.g., a trusted data structure) in order to obtain a difference. The difference may be zero (e.g., when the hash values match) or nonzero (e.g., when the hash values do not match). If the difference is zero, for example, then the result may indicate that the at least one measurement is the trusted measurement. Otherwise, if the difference is nonzero, then the result may indicate that the at least one measurement is not the trusted measurement.

At operation 326, operation of the device may be managed based on the at least one measurement. For example, if the measurement is the trusted measurement, managing the operation of the device may include: (i) permitting the device to boot, (ii) allowing the device to communicate with the data processing system, (iii) allowing the device to access data stored in the data processing system, and/or (iv) other methods. If the measurement is not the trusted measurement, managing operation of the device may include: (i) logging information regarding the trustworthiness of the device, (ii) preventing the device from performing at least a portion of its functionality, and/or (iii) other methods.

The method may end following operation 326.

Thus, as illustrated above, embodiments disclosed herein may provide systems and methods to facilitate startups of a data processing system in a manner that improves startup speed. By using trust stores to determine levels of trust in devices, a full certificate analysis process may not have to be performed for each device during every startup. In doing so, the security of the data processing system may be maintained while reducing resource consumption during the startup.

Any of the components illustrated in FIGS. 1-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
during a startup of the data processing system:
obtaining, by an entity of the data processing system and using a security protocol and data model (SPDM) security standard, at least a first device certificate of a certificate chain for a device of the data processing system, the certificate chain comprising the at least the first device certificate and a root certificate;
performing, by the entity and using the at least the first device certificate and a store of trusted device certificates, a first analysis process to determine a level of trust in the device;
in a first instance of the performing in which the level of trust in the device is indeterminate:
performing, by the entity and using the certificate chain and a store of trusted root certificates, a second analysis process to determine the level of trust in the device; and
managing operation of the data processing system based on the level of trust in the device to reduce a likelihood of the data processing system being compromised.

2. The method of claim 1, wherein the store of trusted device certificates comprises device certificates and/or digests of device certificates.

3. The method of claim 2, wherein performing the first analysis process comprises:
obtaining a digest of the at least the first device certificate; and
identifying, based on the digest of the at least the first device certificate and the digests of device certificates in the store of trusted device certificates, the level of trust in the device.

4. The method of claim 1, wherein performing the second analysis process comprises:
performing a signature verification process to establish trust in each portion of the certificate chain;
identifying, using the store of trusted root certificates, whether a root certificate authority for the root certificate is trusted by the entity to obtain the level of trust in the device; and
in an instance of the identifying in which the level of trust is trusted:
updating the store of trusted device certificates for use during future startups of the data processing system.

5. The method of claim 1, further comprising:
in a second instance of the performing the first analysis process in which the level of trust in the device is trusted:
performing, by the entity, a measurement process using the SPDM security standard for the device to obtain at least one measurement; and
managing operation of the device based on the at least one measurement.

6. The method of claim 5, wherein the at least one measurement comprises security data usable to validate authenticity and/or integrity of software hosted by the device.

7. The method of claim 1, wherein no other portions of the certificate chain other than the first device certificate are used during the first analysis process.

8. The method of claim 1, further comprising:
in a third instance of the performing the first analysis process in which the level of trust in the device is untrusted:
preventing the device from performing at least a portion of its functionality, and/or logging information regarding trustworthiness of the device.

9. The method of claim 1, wherein the SPDM security standard is a data model for devices of data processing systems, the SPDM security standard specifying, at least, methods of security communication between the devices, minimum standards of data to be made available to other devices, and security information to be made available to the other devices.

10. The method of claim 1, wherein the entity of the data processing system is a basic input-output system (BIOS).

11. A non-transitory machine-readable medium having instructions stored therein, which when executed by a processor, cause the processor to perform operations for managing operation of a data processing system, the operations comprising:
during a startup of the data processing system:
obtaining, by an entity of the data processing system and using a security protocol and data model (SPDM) security standard, at least a first device certificate of a certificate chain for a device of the data processing system, the certificate chain comprising the at least the first device certificate and a root certificate;
performing, by the entity and using the at least the first device certificate and a store of trusted device certificates, a first analysis process to determine a level of trust in the device;
in a first instance of the performing in which the level of trust in the device is indeterminate:
performing, by the entity and using the certificate chain and a store of trusted root certificates, a second analysis process to determine the level of trust in the device; and
managing operation of the data processing system based on the level of trust in the device to reduce a likelihood of the data processing system being compromised.

12. The non-transitory machine-readable medium of claim 11, wherein the store of trusted device certificates comprises device certificates and/or digests of device certificates.

13. The non-transitory machine-readable medium of claim 12, wherein performing the first analysis process comprises:
obtaining a digest of the at least the first device certificate; and
identifying, based on the digest of the at least the first device certificate and the digests of device certificates in the store of trusted device certificates, the level of trust in the device.

14. The non-transitory machine-readable medium of claim 11, wherein performing the second analysis process comprises:
performing a signature verification process to establish trust in each portion of the certificate chain;
identifying, using the store of trusted root certificates, whether a root certificate authority for the root certificate is trusted by the entity to obtain the level of trust in the device; and
in an instance of the identifying in which the level of trust is trusted:
updating the store of trusted device certificates for use during future startups of the data processing system.

15. The non-transitory machine-readable medium of claim 11, further comprising:
in a second instance of the performing the first analysis process in which the level of trust in the device is trusted:
performing, by the entity, a measurement process using the SPDM security standard for the device to obtain at least one measurement; and
managing operation of the device based on the at least one measurement.

16. A data processing system, comprising:
a processor; and
a memory coupled to the processor to store instructions, which when executed by the processor, cause the processor to perform operations for managing operation of a data processing system, the operations comprising:
during a startup of the data processing system:
obtaining, by an entity of the data processing system and using a security protocol and data model (SPDM) security standard, at least a first device certificate of a certificate chain for a device of the data processing system, the certificate chain comprising the at least the first device certificate and a root certificate;
performing, by the entity and using the at least the first device certificate and a store of trusted device certificates, a first analysis process to determine a level of trust in the device;
in a first instance of the performing in which the level of trust in the device is indeterminate:
performing, by the entity and using the certificate chain and a store of trusted root certificates, a second analysis process to determine the level of trust in the device; and
managing operation of the data processing system based on the level of trust in the device to reduce a likelihood of the data processing system being compromised.

17. The data processing system of claim 16, wherein the store of trusted device certificates comprises device certificates and/or digests of device certificates,

18. The data processing system of claim 17, wherein performing the first analysis process comprises:
obtaining a digest of the at least the first device certificate; and
identifying, based on the digest of the at least the first device certificate and the digests of device certificates in the store of trusted device certificates, the level of trust in the device.

19. The data processing system of claim 16, wherein performing the second analysis process comprises:
performing a signature verification process to establish trust in each portion of the certificate chain;
identifying, using the store of trusted root certificates, whether a root certificate authority for the root certificate is trusted by the entity to obtain the level of trust in the device; and
in an instance of the identifying in which the level of trust is trusted:
updating the store of trusted device certificates for use during future startups of the data processing system.

20. The data processing system of claim 16, further comprising:
in a second instance of the performing the first analysis process in which the level of trust in the device is trusted:
performing, by the entity, a measurement process using the SPDM security standard for the device to obtain at least one measurement; and
managing operation of the device based on the at least one measurement.
